(19) United States
(12) Patent Application Publication
(10) Pub. No.: US 2019/0068397 A1
(43) Pub. Date: Feb. 28, 2019

(54) METHOD AND SYSTEM FOR PROTOCOL AWARE UNIVERSAL SERIAL BUS REDRIVER

(71) Applicant: Intel Corporation, Santa Clara, CA (US)

(72) Inventor: Huimin CHEN, Beaverton, OR (US)

(21) Appl. No.: 15/469,462

(22) Filed: Mar. 24, 2017

(51) Int. Cl. H04L 12/40

(52) U.S. Cl. CPC H04L 12/40

(57) ABSTRACT

A method for providing a protocol aware repeater in a link of a communication medium. The repeater receives a signal over the link from a host, driver or repeater connected to the link, equalizes the signal to counteract attenuation of the signal, forwards the signal toward a destination on the link, recovers a clock associated with the signal, performs symbol recovery on the signal, and decodes the signal, where the recovering, symbol recovery and decoding are in parallel with or after the forwarding of the signal.

### TECHNICAL FIELD

Embodiments relate to the field of interconnections for computing devices; and more specifically, to the operations of Universal Serial Buses in handling signaling over distances requiring a redriver or repeater.

### BACKGROUND

The Universal Serial Bus (USB) standard is a standard that defines cables, connections and communication protocols used for connection, communication and power supply between electronic devices. The USB standard has evolved over time to utilize various connector types, to support varying data rates and to support varying features. For example, the USB version 3.1 Gen 2 introduced a data rate that doubled the USB Gen 1 data rate, however, this has led to increased channel loss which in turn increases the need for repeaters within USB links. This includes the use of a repeater in some platforms to compensate for this channel loss and preserve the system routing requirement in terms of signal integrity. Likewise, there is an increasing use of longer USB cables that require repeaters in the cable itself to support the extended lengths. As a result, new connectivity models emerged in USB 3.1 that include multiple repeaters between the USB host and device. The use of repeaters can address the signal integrity needs of a system, but they also introduce propagation delay that needs to be accounted for in both USB Gen 1 and Gen 2 data rates.

There are different types of repeaters that can be used with USB communication mediums. These repeaters include re-drivers and re-timers. A repeater refers to any active component that acts on a signal in order to increase the physical lengths or distance the signal can be successfully transmitted and that counteracts various types of interconnect loss to ensure the signal can be transmitted successfully.

A re-timer refers to a component that contains a clock-data recovery (CDR) circuit that “retimes” the signal. The re-timer latches the signal into a synchronous memory element before re-transmitting it. A re-timer is used to extend the physical length or distance the signal can be successfully transmitted within a medium or system without accumulating high frequency jitter by creating separate clock domains on either side of the re-timer. Furthermore, a re-timer can be implemented based on a separate reference clock independent signal sensor conditioner re-timer or a bit-level re-timer.

A re-driver refers to an analog component that operates on the signal without re-timing it. This may include equalization, amplification, and transmitter. The re-driver does not include a CDR. Re-timers can include a captive re-timer or a link segment re-timer. A captive re-timer refers to a re-timer that is located on the same host or device system. The re-timer is associated with the host or device. A link segment re-timer is situated in a cable or similar medium between a host and device where a link segment refers to a transmitter-channel-receiver combination between a downstream port and a re-timer upstream port, an upstream port and a re-timer, or two re-timers.

### BRIEF DESCRIPTION OF THE DRAWINGS

The present disclosure is illustrated by way of example and not limitation in the figures of the accompanying drawings, in which like references indicate similar elements and in which:

FIG. 1 is a diagram of one embodiment of a link including a host, repeater and device.

FIG. 2 is a diagram of one embodiment of a re-driver circuit for a Universal Serial Bus (USB) link.

FIG. 3 is a diagram of one embodiment of a re-trimer circuit for the USB link.

FIG. 4 is a diagram of one embodiment of a protocol aware re-driver for a USB link.

FIG. 5 is a flowchart of one embodiment of a process for a protocol aware re-drive.

FIG. 6 is a diagram of one embodiment of a system on a chip (SOC) that may implement aspects of the embodiments.

FIG. 7 is a diagram of computing system including the SOC and components that implemented the embodiments.

### DETAILED DESCRIPTION

The embodiments provide a set of processes and mechanisms that provide a protocol aware Universal Serial Bus (USB) repeater. The embodiments provide a repeater in the form of a cost effective redriving repeater that is protocol aware for any USB version such as USB 3.1 or similar communication protocols. The embodiments provide an improvement over repeaters that are either redriver based but not protocol aware, or are re-timer based with a high cost design due to higher complexity and additional components. The basic principle of a protocol aware redriving repeater (i.e., a redriver) according to the embodiments is to utilize the analog redriver functions to perform the signal restoration, just like a typical re-driver, and add a data recovery function, which is only part of a re-timer function such that the redriver is aware of the content of the communications between the host and device which enable the redriver to maintain its operations consistent and compliant to USB specifications such as the USB 3.1 specification (i.e., the USB 3.1 Specification released on Jul. 26, 2013).

As data rates increase with USB and similar communication protocols, the electrical signals carrying communication in the medium are increasingly susceptible to interference and loss. Repeaters are used in the medium to avoid such issues and to maintain the quality of the signal across the medium. There are two general implementations for repeaters, a redriver and a retimer. A redriver based repeater only re-conditions the analog signals without decoding the signals, thus the redriver does not have information about the content of the communications, i.e., it is not ‘protocol aware.’ The redriver implementation, although a low-cost implementation with very low latency, suffers from several deficiencies. These deficiencies include that the redriver cannot perform link power management in accordance with the USB specification because it is not protocol aware. The redriver would require a specialized implementation inconsistent with the USB specification to determine whether the link has transitioned to a low power state. The USB 3.1 specification relies on link commands to enable the host, device and repeaters to negotiate and inform each other prior to entering a low power state. The USB 3.1 specification does not define any electrical threshold level for a receiver such as a repeater to determine when entry to low power state may occur. As a result, all USB 3.1 redriver implementations are proprietary and the interoperability between a redriver and host or device may not be guaranteed.

A retiming based repeater (referred to herein as a ‘retimer’) re-conditions the received signal through a digital approach. The retimer operation is based on the retimer first recovering received clock and data in the digital domain, and then re-transmitting the recovered digital data. A retimer can further be configured to be protocol aware by performing additional symbol recovery and packet decoding. This allows a retimer to intercept communications between a host and device, thus facilitating a concerted retimer operation with the host and device. However, retimers also suffer from higher cost in terms of extra components and complexity. One of these extra costs is the need of an external reference clock for operation of the retimer. The retimer also incurs additional link delay inherent to retimer architecture that compromises the link performance and interoperability.

The embodiments overcome these deficiencies of redrivers and retimers by providing a protocol aware redriver that combines the best qualities of redrivers and retimers, by redriving to re-condition the received signal to minimize the repeater delay, and performing data/symbol recovery without needing a reference clock to achieve protocol awareness, thus enabling a new type of low cost repeater implementation that can be fully compliant to USB 3.1 specification operations or compliant with similar communication protocols.

In the following description, numerous specific details are set forth. However, it is understood that embodiments of the disclosure may be practiced without these specific details. In other instances, well-known circuits, structures, and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Electronics (e.g., computing systems) generally employ one or more electrical connections (e.g., wired or wireless connections) to facilitate the transmission and reception of data (e.g., communication) between devices, such as, but not limited to, between a computing system (e.g., a computer including a hardware processor) and a (e.g., external) peripheral. Non-limiting examples of peripherals are external storage devices (e.g., hard disk drives) and mobile devices (e.g., smartphones and tablets).

Certain electrical connections (e.g., couplings) include parallel conductors (e.g., parallel wires or other electrically conductive paths). One embodiment of an electrical connection is a bus. One embodiment of a bus is a multiple conductor bus, for example, where the conductors (e.g., wires) allow parallel (e.g., concurrent) transmittal of data thereon. The term electrical connection (e.g., bus) may generally refer to one or more separate physical connections, communication lines and/or interfaces, shared connections, and/or point-to-point connections, which may be connected by appropriate bridges, hubs, adapters, and/or controllers. A serial bus (e.g., serial bus architecture) may generally refer to a (e.g., shared) communication channel that transmits data one bit after another (e.g., sequentially), for example, over a (e.g., each) single wire or fiber.

As used herein, the phrase Universal Serial Bus (USB) generally refers to a specification(s) for a serial bus that supports the transmission and reception of data (e.g., and power and/or control) between a downstream facing port (e.g., a host) and any one or more upstream facing ports (e.g., devices), for example, through one or more hubs there between.

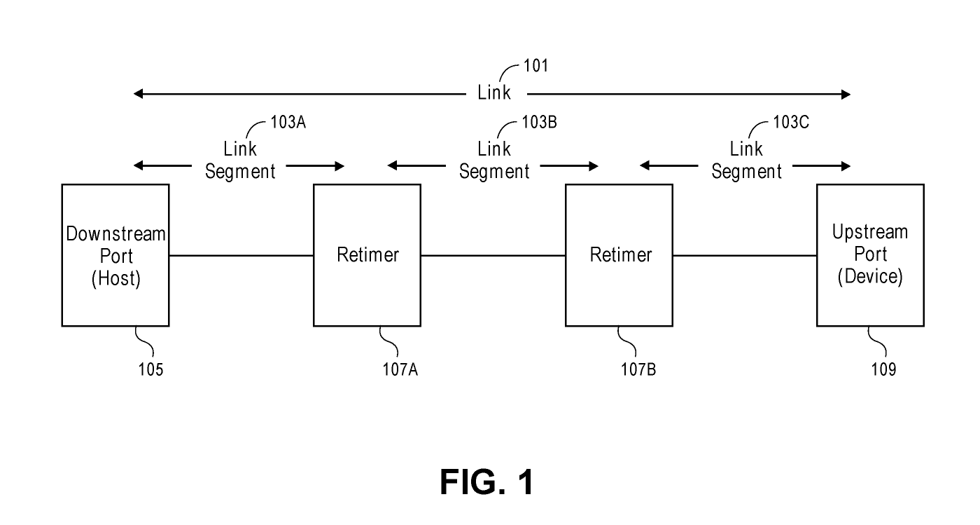

FIG. 1 is a diagram of one embodiment of a link including a host, repeater and device. The link 101 is provided by way of example of a simplified illustration of link connectivity between a host 105 and a device 109 with two repeaters 107A, 107B in between. The link 101 is sub-divided into link segments 103A-C. The link 101 and link segments 103A-C can have any length of configuration. Where the link exceeds a distance over which the signal can be sent between the host 105 and device 109 and successfully decoded, then repeaters may be inserted in the link 101. The portion of the link 101 between a host 105 and device 109 or between the host 105 or device 109 and repeaters 107A, 107B or any combination thereof.

A transmitted signal may originate from either the host 105 or device 109, upon reaching the repeaters 107A, 107B, the signal may be attenuated and distorted, due to the fact that channels connecting between the host 105 and device 109 present themselves as a low pass filter. The repeater is placed between host 105 and device 109 to restore the weakened signal such that it may reach its farther destination.

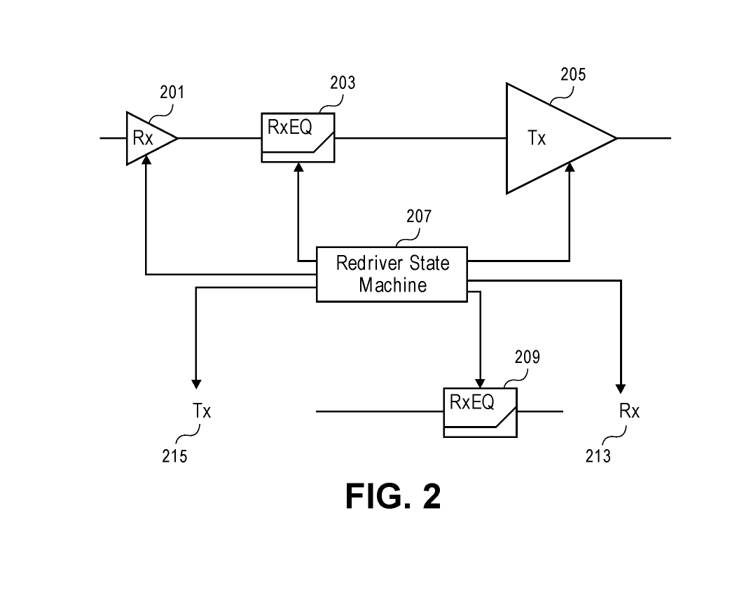

FIG. 2 is a diagram of one embodiment of a redriver circuit for a Universal Serial Bus (USB) link. The redriver consists of an analog receiver 201 with a configurable Continuous Time Linear Equalizer (CTLE) 203 circuit, followed by a transmitter 205 with a gain element. The linearity of the signal is preserved by the redriver in this data path such that the received signal that is attenuated and distorted through the channel is restored to its original electrical and timing condition at the source. In some embodiments of a redriver, the receiver also includes a squelch detector. The function of a squelch detector is to determine the end of data transmission so that the redriver, upon detecting a squelched condition, will disable its transmitter accordingly. In USB 3.1 operation, this happens when host and device have negotiated to enter a low power link state where traffic is temporarily unavailable. Since the redriver has no knowledge of host/device communication, it has to rely on a non-standard squelch detector to determine the electrical idle, which is an indicator of a link being in an idle state. The redriver uses that to terminate transmissions on the data path and to enter a low power state to save power. Because of this non-standard implementation, relative to communication protocol compliance (e.g., USB 3.1), a redriver does not work very well in managing its operational state and power consumption when in an idle state.

A redriver state machine (RSM) 207 manages redriver operation under various link states. For example, the RSM may manage the link power state based on monitored signal levels. However, the RSM is not protocol aware and is only able to manage state based on analog signal monitoring. In some embodiments, the RSM may be in communication with additional outputs to additional transmission and receiver components as well as additional equalizer components 209. These components service the signals sent in the opposite direction of the bi-directional link.

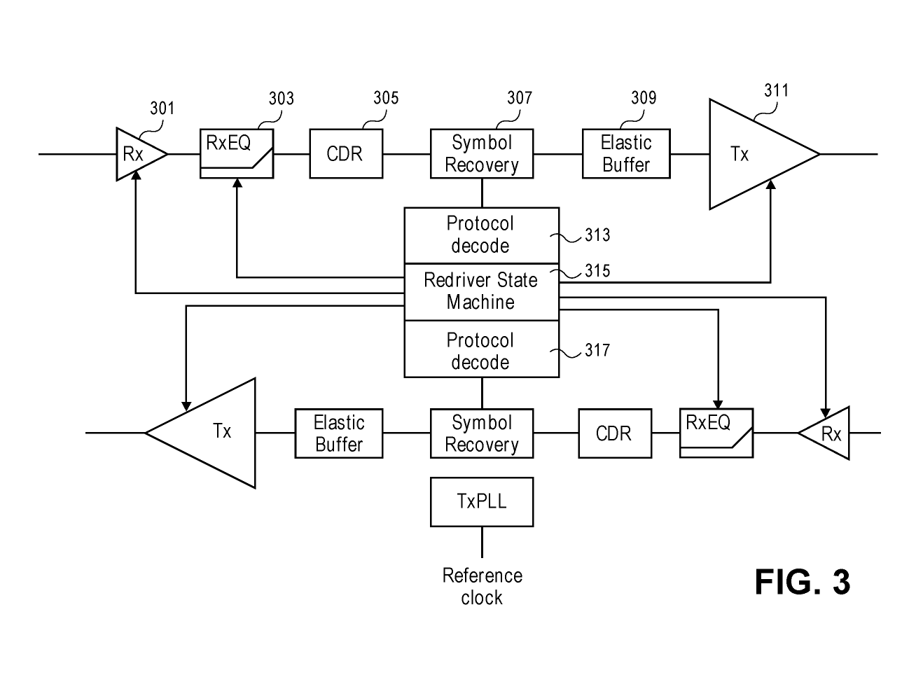

FIG. 3 is a diagram of one embodiment of a retimer circuit for the USB link. While the example of USB is provided, one skilled in the art would understand that the principles and structures of the This retimer circuitry may also apply to other similar types of links such as peripheral component interconnect express (PCIe), and MIPI alliance physical layer (M-PHY) since those link types share similar retimer circuitry where the protocol decode would incorporates PCIe and M-PHY based application protocols instead of USB. The re-timer circuit includes a receiver 301 and equalizer 303 similar to the redriver. A clock data recovery block (CDR) 305 is introduced to convert the received analog signal into a digital format, which is subsequently symbol locked by a symbol recover unit 307 for protocol decode 313. The recovered symbol is also fed into an elastic buffer (EB) 309 for transmission based on a local transmit clock generated by a transmission (Tx) phase locked loop (PLL) 311. A retimer state machine 315 determines the state of the retimer circuit based on command received and decoded by the retimer. As with the redriver, the retimer includes additional components that mirror those described to support bi-directional communication with the retimer state machine in some embodiments shared between the components.

While the retimer is capable of protocol awareness to synchronize its operation with a host or device, it also introduces additional data path delay and an external reference clock is required to ensure that a transmitted signal is compliant to the electrical and timing specification, thus adding cost and adding latency in the retransmission. Specifically, the CDR 303 and symbol recovery 307 as well as the elastic buffer 309, which are in-line to the retransmission of the received signal introduce latency to the retimer.

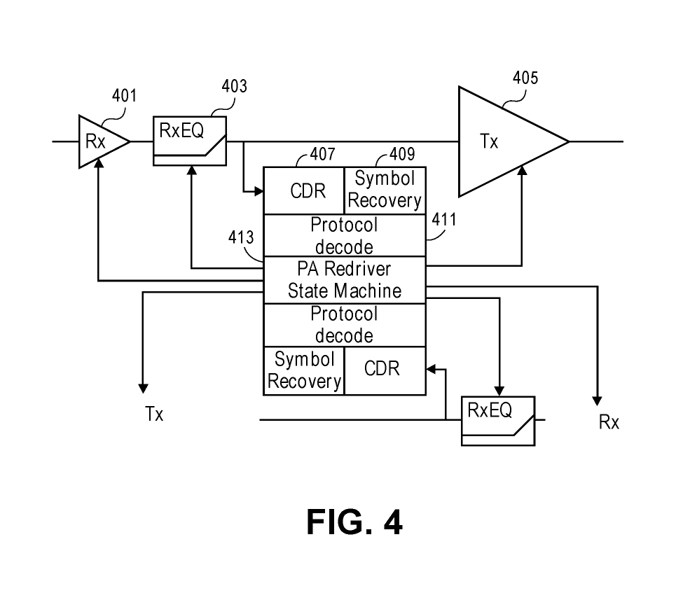

FIG. 4 is a diagram of one embodiment of a protocol aware redriver for a USB link. In one embodiment, the protocol aware redriver includes a receiver 401, equalizer 403 and transmitter 405 that are in-line and which insert no additional latency with relation to a redriver as illustrated in FIG. 2. The protocol aware redriver includes a CDR 407, symbol recovery circuit 409, protocol decoder 411 and a protocol aware (PA) redriver state machine 413. These components are not in-line with the signal receiver 401 and transmitter 405 and thus do not affect the latency of this signal retransmission. These retimer structures and processes may be capable of supporting other IO links such as PCIe and M-PHY based protocols where the retimer is also protocol aware to PCIe and M-PHY based applications.

As compared to the redriver and retimer implementations shown in FIGS. 2 and 3, the data path of the protocol aware redriver remains analog and no delay is added thereby avoiding the latency additions caused by a retimer such as the retimer of FIG. 3. The analog signal is tapped (i.e., processed in parallel to retransmission) at the same time to allow the redriver to achieve data recovery in order to be protocol aware, thus eliminating any need for a power consuming non-standardized (i.e., incompatible with the USB 3.1 specification) squelch detector that may be used in a non-protocol aware redriver implementation to determine whether the link has entered a low power state. Because no Tx PLL (transmission phase lock loop) is required in this embodiment of the protocol aware redriver, no external reference clock is required.

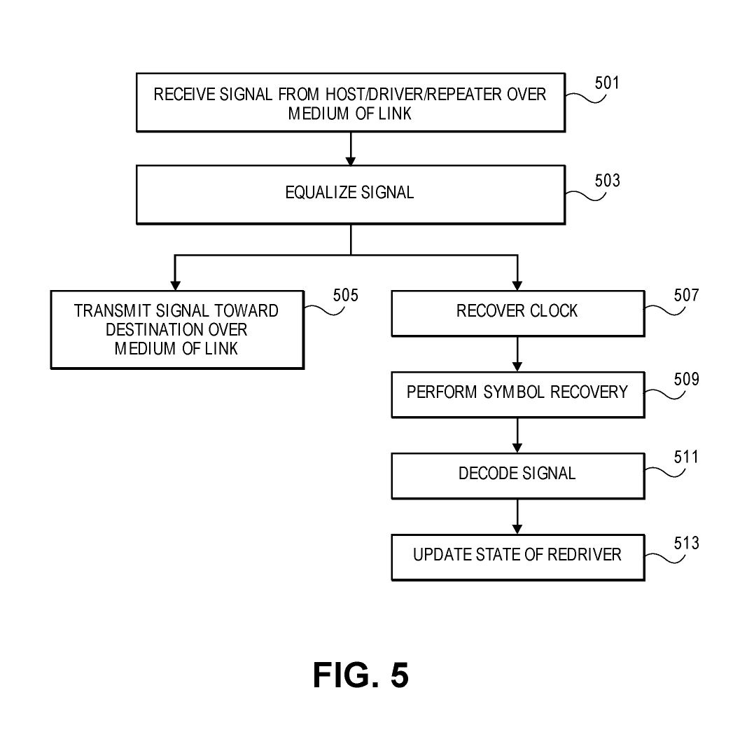

FIG. 5 is a flowchart of one embodiment of a process for a protocol aware re-driver. The protocol aware redriver processes received signals from hosts, devices and other repeaters that are transmitted to be compliant with a communication protocol such as USB (e.g., USB 3.1 specification) (Block 501). The signal may have been transmitted over the link by a host, device or another repeater. The received signal is then processed by an equalizer or similar component to recover and boost the signal for retransmission (Block 503). The signal is then retransmitted over the link to the next device, host or repeater over the link (Block 505).

In parallel, the received signal is tapped or processed to recover the clock in a CDR (Block 507). The signal is then processed with the recovered clock to perform symbol recovery (Block 509). The recovered symbols can then be decoded to determine the content of the signal (Block 511). This includes decoding commands of the communication protocol, such as decoding USB 3.1 power management commands.

The decoded information can then be processed by a state machine to update the state of the redriver in accordance with the decoded command or similar information (Block 513). The decoded information enables the state machine to recognize commands of a given protocol that affect the operation of the link. For example, the state machine may be configured to match or identify a command that changes the operation of the link to a low power state or that exits a low power state. The state machine can track these commands as they are received from both directions on the link to determine the appropriate state of the link and the redriver in accordance with the communication protocol.

In one example embodiment, the state machine manages the power state of the redriver and where the host and device communicate commands on each direction of the link to lower the power state or reactive the power state the state machine can identify the commands as they traverse the redriver in each direction. The redriver may change the power state and other operating characteristics of the redriver to conserve power or similarly alter the operation of the link as it is affected by the redriver.

Each of these functions can be implemented in circuits or hardware components with an architecture as described in relation to FIG. 4. In addition, any of these operations can be executed by a processor or microcontroller that executes instructions or is micro-coded to perform any of the described operations. These operations can be implemented by any combination of hardware circuits, coding or micro-coding.

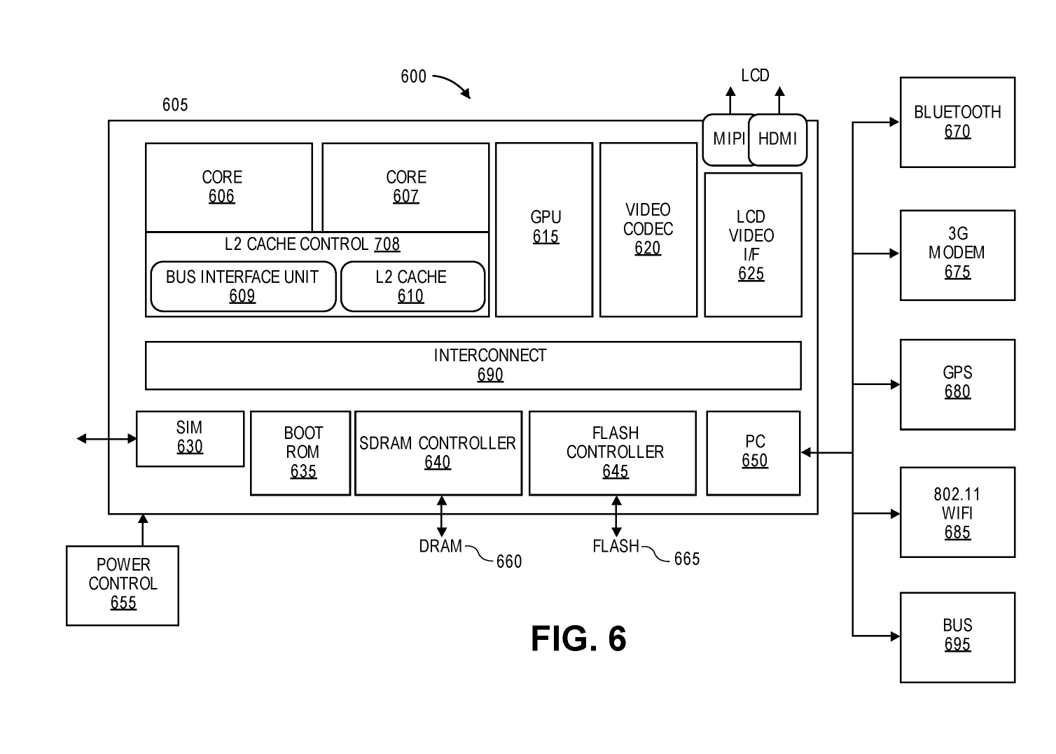

FIG. 6 is a diagram of one embodiment of a system on-chip (SOC) design that may be utilized to implement the embodiments. As a specific illustrative example, SOC 600 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 600 includes 2 cores-606 and 607. Cores 606 and 607 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 606 and 607 are coupled to cache control 608 that is associated with bus interface unit 609 and L2 cache 610 to communicate with other parts of system 600. Interconnect 690 includes an on-chip interconnect, such as an Intel on chip system fabric (IOSF), advanced microcontroller bus architecture (AMBA), or other interconnect, which potentially implements one or more aspects of the described embodiments.

Interconnect 690 provides communication channels to the other components, such as a Subscriber Identity Module (SIM) 630 to interface with a SIM card, a boot ROM 635 to hold boot code for execution by cores 606 and 607 to initialize and boot SOC 600, a SDRAM controller 640 to interface with external memory (e.g. DRAM 660), a flash controller 645 to interface with non-volatile memory (e.g. Flash 765), a peripheral control 650 (e.g. Serial Peripheral Interface) to interface with peripherals, video codecs 620 and Video interface 625 to display and receive input (e.g. touch enabled input), graphic processing unit (GPU) 615 to perform graphics related computations, etc. Any of these interfaces may incorporate aspects of the embodiments described herein.

In addition, the system illustrates peripherals for communication, such as a Bluetooth module 670, 3G modem 675, GPS 680, and WiFi 685. Note as stated above, a UE includes a radio for communication. As a result, these peripheral communication modules are not all required. However, in a UE some form a radio for external communication is to be included. The UE can include a USB controller 695 that may communicate over a link or set of links with other components either internal or external to the UE and where a repeater such as the embodiments of a protocol aware redriver may be utilized in the link. In further embodiments, the USB controller 695 may be a sub-component of the peripheral communication modules or the peripheral communication module may be a USB controller 695.

Note that the apparatus, methods, and systems described above may be implemented in any electronic device or system as aforementioned. As specific illustrations, the figures below provide exemplary systems for utilizing the embodiments as described herein. As the systems below are described in more detail, a number of different interconnects are disclosed, described, and revisited from the discussion above. And as is readily apparent, the advances described above may be applied to any of those interconnects, fabrics, or architectures.

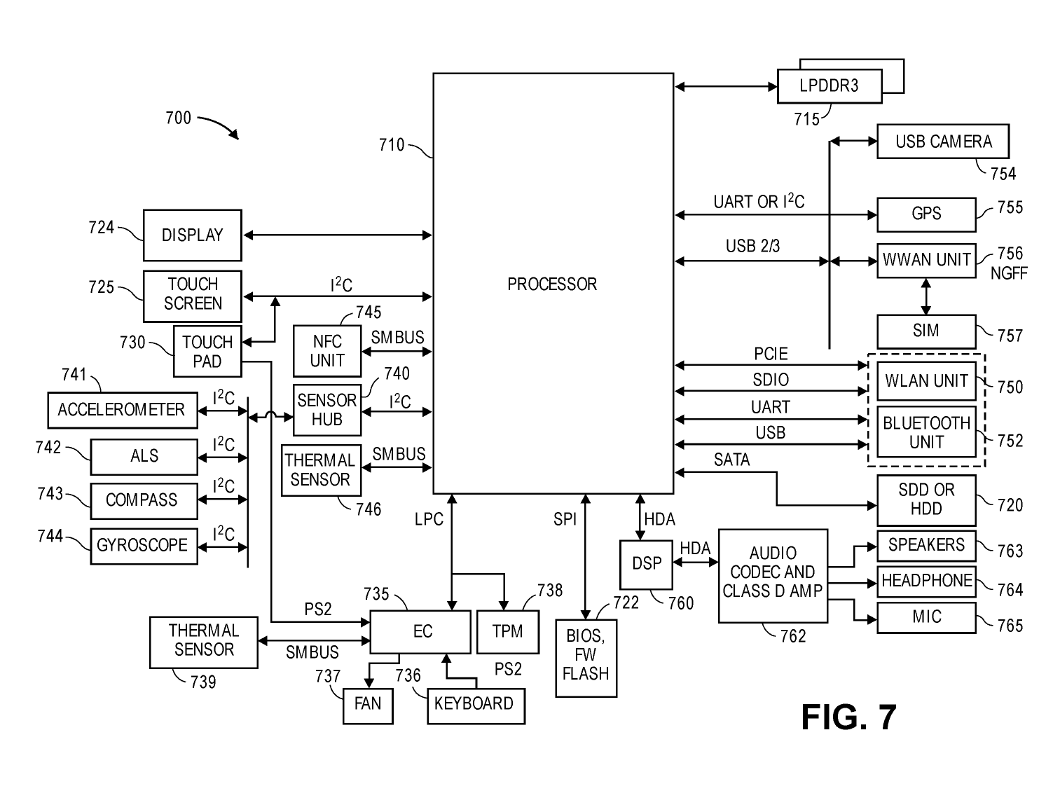

FIG. 7 a block diagram of components present in a computer system as an example implementation of the components of the embodiments. As shown in FIG. 7, system 700 includes any combination of components. These components may be implemented as integrated circuits (ICs), portions thereof, discrete electronic devices, or other modules, logic, hardware, software, firmware, or a combination thereof adapted in a computer system, or as components otherwise incorporated within a chassis of the computer system. Note also that the block diagram of FIG. 7 is intended to show a high-level view of many components of the computer system. However, it is to be understood that some of the components shown may be omitted, additional components may be present, and different arrangement of the components shown may occur in other implementations. As a result, the embodiments described above may be implemented in any portion of one or more of the interconnects illustrated or described below.

As seen in FIG. 7, a processor 710, in one embodiment, includes a microprocessor, multi-core processor, multithreaded processor, an ultra low voltage processor, an embedded processor, or other known processing element. In the illustrated implementation, processor 710 acts as a main processing unit and central hub for communication with many of the various components of the system 700. As one example, processor 710 is implemented as a system on a chip (SoC). As a specific illustrative example, processor 710 includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitectural implementation may vary, but the architectural function of the processor is usually consistent. Certain details regarding the architecture and operation of processor 710 in one implementation will be discussed further below to provide an illustrative example.

Processor 710, in one embodiment, communicates with a system memory 715. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2011), or a next generation LPDDR standard to be referred to as LPDDR3 or LPDDR4 that will offer extensions to LPDDR2 to increase bandwidth. In various implementations, the individual memory devices may be of different package types such as single die package (SDP), dual die package (DDP) or quad die package (Q17P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 720 may also couple to processor 710. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, shown in FIG. 7, a flash device 722 may be coupled to processor 710, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

Various input/output (TO) devices may be present within system 700. Specifically shown in the embodiment of FIG. 7 is a display 724 which may be a high definition LCD or LED panel configured within a lid portion of the chassis. This display panel may also provide for a touch screen 725, e.g., adapted externally over the display panel such that via a user's interaction with this touch screen, user inputs can be provided to the system to enable desired operations, e.g., with regard to the display of information, accessing of information and so forth. In one embodiment, display 724 may be coupled to processor 710 via a display interconnect that can be implemented as a high-performance graphics interconnect. Touch screen 725 may be coupled to processor 710 via another interconnect, which in an embodiment can be an I²C interconnect. As further shown in FIG. 7, in addition to touch screen 725, user input by way of touch can also occur via a touch pad 730 which may be configured within the chassis and may also be coupled to the same I²C interconnect as touch screen 725.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode, the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments, the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080p), be compatible with an embedded display port (eDP), and be a low power panel with panel self-refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited IO interference when using multi-touch.

For perceptual computing and other purposes, various sensors may be present within the system and may be coupled to processor 710 in different manners. Certain inertial and environmental sensors may couple to processor 710 through a sensor hub 740, e.g., via an I²C interconnect. In the embodiment shown in FIG. 7, these sensors may include an accelerometer 741, an ambient light sensor (ALS) 742, a compass 743 and a gyroscope 744. Other environmental sensors may include one or more thermal sensors 746 which in some embodiments couple to processor 710 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example, with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

In an embodiment, the OS may be a Microsoft® Windows® 8 OS that implements Connected Standby (also referred to herein as Win8 CS). Windows 8 Connected Standby or another OS having a similar state can provide, via a platform as described herein, very low ultra idle power to enable applications to remain connected, e.g., to a cloud-based location, at very low power consumption. The platform can support 3 power states, namely screen on (normal); Connected Standby (as a default “off” state); and shutdown (zero watts of power consumption). Thus in the Connected Standby state, the platform is logically on (at minimal power levels) even though the screen is off In such a platform, power management can be made to be transparent to applications and maintain constant connectivity, in part due to offload technology to enable the lowest powered component to perform an operation.

Also, seen in FIG. 7, various peripheral devices may couple to processor 710 via a low pin count (LPC) interconnect. In the embodiment shown, various components can be coupled through an embedded controller (EC) 735. Such components can include a keyboard 736 (e.g., coupled via a PS2 interface), a fan 737, and a thermal sensor 739. In some embodiments, touch pad 730 may also couple to EC 735 via a PS2 interface. In addition, a security processor such as a trusted platform module (TPM) 738 in accordance with the Trusted Computing Group (TCG) TPM Specification Version 1.2, dated Oct. 2, 2003, may also couple to processor 710 via this LPC interconnect. However, understand the scope of the present disclosure is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with a Universal Serial Bus specification, with at least one powered for charging of USB devices (such as smartphones) when the system is in Connected Standby state and is plugged into AC wall power. These USB ports and the associated links may implement the embodiments described herein with relation to the use of protocol aware repeaters in links and support for such devices in USB controllers. In addition, one or more Thunderbolt™ ports can be provided. Other ports may include an externally accessible card reader such as a full size SD-XC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System 700 can communicate with external devices in a variety of manners, including wirelessly. In the embodiment shown in FIG. 7, various wireless modules, each of which can correspond to a radio configured for a particular wireless communication protocol, are present. One manner for wireless communication in a short range such as a near field may be via a near field communication (NFC) unit 745 which may communicate, in one embodiment with processor 710 via an SMBus. Note that via this NFC unit 745, devices in close proximity to each other can communicate. For example, a user can enable system 700 to communicate with another (e.g.,) portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 7, additional wireless units can include other short range wireless engines including a WLAN unit 750 and a Bluetooth unit 752. Using WLAN unit 750, Wi-Fi™ communications in accordance with a given Institute of Electrical and Electronics Engineers (IEEE) 802.11 standard can be realized, while via Bluetooth unit 752, short range communications via a Bluetooth protocol can occur. These units may communicate with processor 710 via, e.g., a USB link or a universal asynchronous receiver transmitter (UART) link. These USB links may implement the embodiments described herein with relation to the use of protocol aware repeaters in links and support for such devices in USB controllers. Or these units may couple to processor 710 via an interconnect according to a Peripheral Component Interconnect Express™ (PCIe™) protocol, e.g., in accordance with the PCI Express™ Specification Base Specification version 3.0 (published Nov. 10, 2010), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 756 which in turn may couple to a subscriber identity module (SIM) 757. In addition, to enable receipt and use of location information, a GPS module 755 may also be present. Note that in the embodiment shown in FIG. 7, WWAN unit 756 and an integrated capture device such as a camera module 754 may communicate via a given USB protocol, e.g., USB 2.0 or 3.1 link, or a UART or I²C protocol. Again the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 760, which may couple to processor 710 via a high definition audio (HDA) link. Similarly, DSP 760 may communicate with an integrated coder/decoder (CODEC) and amplifier 762 that in turn may couple to output speakers 763 which may be implemented within the chassis. Similarly, amplifier and CODEC 762 can be coupled to receive audio inputs from a microphone 765 which in an embodiment can be implemented via dual array microphones (such as a digital microphone array) to provide for high quality audio inputs to enable voice-activated control of various operations within the system. Note also that audio outputs can be provided from amplifier/CODEC 762 to a headphone jack 764. Although shown with these particular components in the embodiment of FIG. 7, understand the scope of the present disclosure is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 710 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

In one embodiment, a sustain power plane can be used during some deep sleep states to power on the I/O pins for several I/O signals, such as the interface between the processor and a PCH, the interface with the external VR and the interface with EC 735. This sustain power plane also powers an on-die voltage regulator that supports the on-board SRAM or other cache memory in which the processor context is stored during the sleep state. The sustain power plane is also used to power on the processor's wakeup logic that monitors and processes the various wakeup source signals.

During power management, while other power planes are powered down or off when the processor enters certain deep sleep states, the sustain power plane remains powered on to support the above-referenced components. However, this can lead to unnecessary power consumption or dissipation when those components are not needed. To this end, embodiments may provide a connected standby sleep state to maintain processor context using a dedicated power plane. In one embodiment, the connected standby sleep state facilitates processor wakeup using resources of a PCH which itself may be present in a package with the processor. In one embodiment, the connected standby sleep state facilitates sustaining processor architectural functions in the PCH until processor wakeup, this enabling turning off all of the unnecessary processor components that were previously left powered on during deep sleep states, including turning off all of the clocks. In one embodiment, the PCH contains a time stamp counter (TSC) and connected standby logic for controlling the system during the connected standby state. The integrated voltage regulator for the sustain power plane may reside on the PCH as well.

In an embodiment, during the connected standby state, an integrated voltage regulator may function as a dedicated power plane that remains powered on to support the dedicated cache memory in which the processor context is stored such as critical state variables when the processor enters the deep sleep states and connected standby state. This critical state may include state variables associated with the architectural, micro-architectural, debug state, and/or similar state variables associated with the processor.

The wakeup source signals from EC 1635 may be sent to the PCH instead of the processor during the connected standby state so that the PCH can manage the wakeup processing instead of the processor. In addition, the TSC is maintained in the PCH to facilitate sustaining processor architectural functions.

Power control in the processor can lead to enhanced power savings. For example, power can be dynamically allocate between cores, individual cores can change frequency/voltage, and multiple deep low power states can be provided to enable very low power consumption. In addition, dynamic control of the cores or independent core portions can provide for reduced power consumption by powering off components when they are not being used.

Some implementations may provide a specific power management IC (PMIC) to control platform power. Using this solution, a system may see very low (e.g., less than 5%) battery degradation over an extended duration (e.g., 16 hours) when in a given standby state, such as when in a Win8 Connected Standby state. In a Win8 idle state a battery life exceeding, e.g., 9 hours may be realized (e.g., at 150 nits). As to video playback, a long battery life can be realized, e.g., full HD video playback can occur for a minimum of 6 hours. A platform in one implementation may have an energy capacity of, e.g., 35 watt hours (Whr) for a Win8 CS using an SSD and (e.g.,) 40-44 Whr for Win8 CS using an HDD with a RST cache configuration.

A particular implementation may provide support for 15 W nominal CPU thermal design power (TDP), with a configurable CPU TDP of up to approximately 25 W TDP design point. The platform may include minimal vents owing to the thermal features described above. In addition, the platform is pillow-friendly (in that no hot air is blowing at the user). Different maximum temperature points can be realized depending on the chassis material. In one implementation of a plastic chassis (at least having to lid or base portion of plastic), the maximum operating temperature can be 52 degrees Celsius (C.). And for an implementation of a metal chassis, the maximum operating temperature can be 46° C.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TXT), and Intel® Manageability Engine Technology along with secure user interfaces such as a secure keyboard and display.

Embodiments (e.g., of the mechanisms) disclosed herein may be implemented in hardware (e.g., a computer programmed to perform a method may be as described in the detailed description), software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code may be executed to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. The mechanisms described herein are not limited in scope to any particular programming language. The language may be a compiled or interpreted language.

One or more aspects of at least one embodiment may be implemented by representative instructions stored on a non-transitory, machine-readable medium which represents various logic within the processor, which when read by a machine causes the machine to fabricate logic to perform the techniques described herein. Such representations, which may be generally referred to as “IP cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

What is claimed is:

1. A method implemented by a repeater in a link of a communication medium, the method comprising:
receiving a signal over the link from a host, driver, or repeater connected to the link;
counteracting attenuation of the signal before forwarding the signal toward a destination on the link; and
decoding the signal according to a protocol of the link, the decoding in parallel with or after the forwarding of the signal.

2. The method of claim 1, further comprising:
updating a state of the repeater based on a content of the decoded signal.

3. The method of claim 1, wherein the decoded signal is processed to determine a protocol command.

4. The method of claim 1, further comprising:
adjusting a power state of the repeater based on the decoded signal.

5. The method of claim 1, wherein the link is a Universal Serial Bus link, peripheral component interconnect express (PCIe), or MIPI alliance physical layer (M-PHY).

6. The method of claim 1, wherein the signal is compliant with Universal Serial Bus version 3.1, peripheral component interconnect express (PCIe), or MIPI alliance physical layer (M-PHY).

7. The method of claim 1, wherein the repeater is a protocol aware redriver.

8. A repeater in a link of a communication medium, the repeater comprising:
a receiver having an input coupled to the link;
an equalizer having an input coupled to an output of the receiver;
a transmitter having an input coupled to an output of the equalizer and an output coupled to the link;
a clock data recovery circuit coupled to an output of the equalizer;
a symbol recovery unit coupled to the output of the clock data recovery circuit;
a protocol decoder coupled to an output of symbol recovery unit;
wherein the clock data recovery circuit, symbol recovery unit and protocol decoder process a signal in parallel with or after the forwarding of the signal by the transmitter.

9. The repeater of claim 8, further comprising:
a state machine coupled to the protocol decoder, the state machine to update a state of the repeater based on a content of the decoded signal.

10. The repeater of claim 8, wherein the state machine processes the decoded signal to determine a protocol command.

11. The repeater of claim 8, further comprising:
a state machine coupled to the protocol decoder, the state machine to adjust a power state of the repeater based on the decoded signal.

12. The repeater of claim 8, wherein the link is a Universal Serial Bus link, peripheral component interconnect express (PCIe), or MIPI alliance physical layer (M-PHY).

13. The repeater of claim 8, wherein the signal is compliant with Universal Serial Bus version 3.1, peripheral component interconnect express (PCIe), or MIPI alliance physical layer (M-PHY).

14. The repeater of claim 8, wherein the repeater is a protocol aware redriver.

15. A non-transitory computer-readable storage medium, having a set of instructions stored therein, which when executed cause a repeater in a link of a communication medium to perform a set of operations comprising:
receiving a signal over the link from a host, driver, or repeater connected to the link;
equalizing the signal to counteract attenuation of the signal;
forwarding the signal toward a destination on the link;
recovering a clock associated with the signal;
performing symbol recovery on the signal; and
decoding the signal,
wherein the recovering, symbol recovery and decoding are in parallel with or after the forwarding of the signal.

16. The non-transitory computer-readable storage medium of claim 15, having further instructions stored therein, which when executed cause the repeater to perform further operations comprising:
updating a state of the repeater based on a content of the decoded signal.

17. The non-transitory computer-readable storage medium of claim 15, wherein the decoded signal is processed to determine a protocol command.

18. The non-transitory computer-readable storage medium of claim 15, having further instructions stored therein, which when executed cause the repeater to perform further operations comprising:
adjusting a power state of the repeater based on the decoded signal.

19. The non-transitory computer-readable storage medium of claim 15, wherein the link is a Universal Serial Bus link, peripheral component interconnect express (PCIe), or MIPI alliance physical layer (M-PHY).

20. The non-transitory computer-readable storage medium of claim 15, wherein the signal is compliant with Universal Serial Bus version 3.1, peripheral component interconnect express (PCIe), or MIPI alliance physical layer (M-PHY).
